(19) United States
(12) Patent Application Publication
(10) Pub. No.: US 2003/0057816 A1
(43) Pub. Date: Mar. 27, 2003

(54) Substrate for electron source formation, electron source, and image-forming apparatus

(76) Inventors: Shuji Yamada, Kanagawa (JP); Tadayasu Meguro, Kanagawa (JP); Satoshi Takezawa, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/251,955

(22) Filed: Sep. 23, 2002

(30) Foreign Application Priority Data
Sep. 25, 2001 (JP) 291014/2001
Sep. 10, 2002 (JP) 263504/2002

(51) Int. Cl. H01J 1/316

(52) U.S. Cl. 313/311

(57) ABSTRACT

A substrate for electron source formation on which a plurality of electron-emitting devices are arranged, comprising a layer where SiO₂ is made a main component on the substrate, wherein an etching rate of the SiO₂ layer at room temperature in 0.4 wt % of hydrogen fluoride ammonium solution (NH₄—HF₂) is 150 nm/min or less reducing the time-dependent change of an electron emission characteristic of an electron-emitting device in low cost, sharply improving the increasing speed of a device current If and the uniformity of final arrival values of If sharply reducing the dispersion of the electron emission characteristic, and an electron source and an image-forming apparatus that each use the substrate.

### BACKGROUND OF THE INVENTION

1. Field of the Invention

The present invention relates to a substrate for electron source formation that is used to form an electron source, an electron source having the substrate for electron source formation on which a plurality of electron-emitting devices etc. are arranged, and an image-forming apparatus.

2. Related Background Art

Heretofore, according to rough classification, two types of electron-emitting devices, that is, a thermionic emission device and a cold cathode electron-emitting device are known. As the cold cathode electron-emitting devices, there are a field emission type (hereafter, an FE type) electron-emitting device, a metal/insulating layer/metal type (hereafter, a MIM type) electron-emitting device, a surface conduction electron-emitting device, etc.

As examples of the FE type electron-emitting device, devices disclosed in references (W. P. Dyke & W. W. Dolan, “Field emission”, Advance in Electron Physics, 8, 89 (1956), and C. A. Splindt, “Physical Properties of Thin-Film Field Emission Cathodes with Molybdenum Cones”, J. Appl. Phys. 47, 5248 (1976), etc.) are known.

As examples of the surface conduction electron-emitting device, there are devices disclosed in references (M. I. Elinson, Recio Eng., Electron Phys., 10, 1290, (1965), etc.). The surface conduction electron-emitting device uses a phenomenon of generating electron emission by flowing a current into a small-area thin film, formed on a substrate, in parallel to a film surface. As these surface conduction electron-emitting devices, the above-described device, using an SnO₂ thin film, by Elinson et al., a device with an Au thin film [G. Dittmer: “Thin Solid Films”, 9, 317 (1972)], a device with an In₂O₂/SnO₂ thin film [M. Hartwell and C. G. Fonstad: “IEEE Trans. ED Conf.”, 519(1975)], a device with a carbon thin film [Hisashi Araki et al., Vacuum, vol. 26, No. 1, pp. 22 (1983)], and the like were reported.

In order to hold an electron source, constituted by arranging such an electron-emitting device like the above-mentioned on a substrate, in an envelope whose interior is kept in vacuum, it is necessary to join the electron source, envelope, and other members together. It is common in this junction to perform heating and fusion by using frit glass. Typical heating temperature at this time is about 400 to 500° C., and, though heating time depends on the size of the envelope and the like, about ten minute to one hour is typical.

In addition, as the material of the envelope, it is preferable to use soda lime glass in the viewpoint of easy and reliable junction with frit glass and of comparatively low cost. Moreover, since high strain point glass where a strain point is raised by substituting K(potassium) for a part of Na(sodium) is easy to perform frit junction, it is possible to preferably use the high strain point glass. Furthermore, also in regard to the material of the above-mentioned substrate for the electron source, it is similarly preferable in view of the reliability of junction with the envelope to use soda lime glass or the above-mentioned high strain point glass.

However, when a surface conduction electron-emitting device is made by the structure described above, a lot of alkali metal, especially Na is contained as Na₂O in the soda lime glass as a component. Since Na elements easily diffuse by heat, Na elements diffuse into various members that are formed on the soda lime glass, in particular, in members that constitute the electron-emitting device when being exposed to high temperature in processing, and hence, characteristics of the members may be deteriorated.

In addition, the influence by Na like the above-mentioned is relaxed in some extent since a Na content is small when the above-mentioned high strain point glass is used as a substrate for an electron source, it is not possible to produce a device with an electron emission characteristic that is sufficient in practical use such as aging.

As means for decreasing the above-mentioned influence of sodium (Na), for example, a substrate for electron source formation where a concentration of the sodium at least in a surface region in the side of a substrate containing sodium, where the electron-emitting device is arranged is smaller than those in other regions, and furthermore, a substrate for electron source formation that has a phosphorus content layer is disclosed in Japanese Patent Application Laid-Open No. 10-241550 and EP-A-850892.

In addition, as a method of blocking Na diffusion more effectively, there is a method of forming a nitride film made of such as SiN and CN with very high hardness, but generally, this method is expensive because of vacuum deposition by sputtering etc.

Furthermore, Japanese Patent Application Laid-Open No. 2000-215789 discloses that it is possible to block Na by forming two layers, that is, a layer including conductive oxide, and a layer including SiO₂, as a Na block layer on a substrate.

Moreover, it has been understood that, as described in Japanese Patent Application Laid-Open No. 09-293448 etc., it is advantageous from the viewpoint of the stability of an electron emission characteristic and the like that a top face of an electron source substrate to which an electron-emitting device contacts is covered with SiO₂.

Then, the present inventor et al. prepared various material as a sodium diffusion preventive layer, performed formation, forming, and activation steps of a device film as described later in detail, and examined an electron emission characteristic in detail.

The activation step means a step of remarkably increasing a device current If and an emission current Ie. In the activation step, for example, a pulse is repeatedly applied to the electron-emitting device unit under the atmosphere where an organic gas is contained. In addition, pulse width, a pulse interval, and a pulse peak value, etc. are properly set. The activation step is properly performed while measuring the device current If and emission current Ie.

As a result, it was found that, in several types of substrates, there were problems that the increasing speed of the device current If and emission current Ie was slow (it takes much time for activation), that a value If that reached finally was low no matter how time was spent, and that its repeatability was bad.

Under such conditions, when actually using the electron-emitting device unit as a display unit, dispersion is caused in the electron emission quantity per pixel to cause uneven luminance, uneven color, and uneven display, and hence, it is not possible to display a very high-quality image.

### SUMMARY OF THE INVENTION

Then, the present invention is to solve the above-mentioned problems and aims at providing a substrate for electron source formation that is inexpensive, that can reduce a time-dependent change in an electron emission characteristic of an electron-emitting device, and that can greatly reduce the dispersion of the electron emission characteristic, and further, an electron source and an image-forming apparatus each of which uses the substrate.

In order to achieve the above-mentioned objects, a substrate for the electron source formation according to the present invention is a substrate for the electron source formation on which a plurality of electron-emitting devices are arranged, and is characterized in that the substrate for an electron source has a layer where SiO₂ is made a main component on the substrate, and that an etching rate of an SiO₂ layer is 150 nm/min or less in 0.4 wt % of hydrogen fluoride ammonium solution (NH₄—HF₂) at room temperature.

In addition, the substrate for electron source formation is a substrate for electron source formation, on which a plurality of electron-emitting devices are arranged, and is characterized in that the substrate has a layer where SiO₂ is made a main component on the substrate, and in that an etching rate of the SiO₂ layer at room temperature in 0.4 wt % of hydrogen fluoride ammonium solution (NH₄—HF₂) is 100 nm/min or less.

Furthermore, the substrate for electron source formation is a substrate for electron source formation, on which a plurality of electron-emitting devices are arranged, and is characterized in that the substrate has a layer where SiO₂ is made a main component on the substrate, and in that an etching rate of the SiO₂ layer in 0.4 wt % of hydrogen fluoride ammonium solution (NH₄—HF₂) at room temperature is 30 nm/min or less.

Moreover, the substrate for electron source formation is a substrate for electron source formation on which a plurality of electron-emitting devices are arranged, and is characterized by comprising a layer where SiO₂ is made a main component on the substrate, in that the layer whose main component is SiO₂ is formed by baking silica sol obtained by hydrolyzing silicon alkoxide, and in that an etching rate of the SiO₂ layer at room temperature in 0.4 Wt % of hydrogen fluoride ammonium solution (NH₄—HF₂) is 150 nm/min or less.

Then, the substrate for electron source formation is a substrate for electron source formation on which a plurality of electron-emitting devices are arranged, and is characterized by comprising a layer where SiO₂ is made a main component on the substrate, in that the layer whose main component is SiO₂ is formed by baking silica sol obtained by hydrolyzing silicon alkoxide, and in that an etching rate of the SiO₂ layer at room temperature in 0.4 Wt % of hydrogen fluoride ammonium solution (NH₄—HF₂) is 100 nm/min or less.

Moreover, the substrate for electron source formation is a substrate for electron source formation on which a plurality of electron-emitting devices are arranged, and is characterized by comprising a layer where SiO₂ is made a main component on the substrate, in that the layer whose main component is SiO₂ is formed by baking silica sol obtained by hydrolyzing silicon alkoxide, and in that an etching rate of the SiO₂ layer at room temperature in 0.4 Wt % of hydrogen fluoride ammonium solution (NH4-HF2) is 30 nm/min or less.

In either of the above-described substrates for electron source formation, it is preferable to have a layer, where fine particles of tin oxide (SnO₂) are made a main component as a first layer, under the above-described layer where SiO₂ is made a main component.

In addition, it is preferable that mean particle size expressed by a median value of fine particles of tin oxide (SnO₂) that is a main component in the above-described first layer is from 15 nm to 30 nm.

Moreover, it is preferable that a main component in the above-described first layer is fine particles of tin oxide (SnO₂), and that 0.5 to 10 wt % of phosphorus (P) is contained in the layer.

In addition, an electron source of the present invention is characterized by comprising any one of the above-mentioned substrates for electron source formation, a plurality of electron-emitting device arranged on a layer where SiO₂ is made a main component, and a plurality of row-directional wirings and a plurality of column-directional wirings that connect the plurality of electron-emitting devices in a matrix.

Furthermore, an image-forming apparatus of the present invention is characterized by comprising the above-mentioned electron source, an image-forming member in which an image-is formed by radiating electrons discharged from the electron source.

### BRIEF DESCRIPTION OF THE DRAWINGS

FIG. 1 is a sectional view showing a second embodiment in a substrate for electron source formation according to the present invention;

FIGS. 2A and 2B are a plan and a sectional view that schematically show the basic structure of a surface conduction electron-emitting device in this embodiment;

FIG. 3 is a plan showing a state of forming device electrodes on a substrate that has electron-emitting devices in a matrix in this embodiment;

FIG. 4 is a plan showing a state of forming Y-directional wiring on a substrate that has electron-emitting devices in a matrix in this embodiment;

FIG. 5 is a plan showing a state of forming an insulating film on a substrate that has electron-emitting devices in a matrix in this embodiment;

FIG. 6 is a plan showing a state of forming X-directional wiring on a substrate that has electron-emitting devices in a matrix in this embodiment;

FIG. 7 is a plan showing a state of forming an electroconductive thin film on a substrate that has electron-emitting devices in a matrix in this embodiment;

FIGS. 8A, 8B, 8C and 8D are schematic diagrams showing an example of a forming method of the electroconductive thin film in this embodiment;

FIGS. 9A and 9B are explanatory diagrams showing forming waveforms in this embodiment;

FIG. 10 is a schematic diagram of measuring and evaluating equipment to measure an electron emission characteristic of an electron-emitting device made according to this embodiment;

FIGS. 11A and 11B are explanatory graphs showing V-I characteristics of the electron-emitting device in this embodiment;

FIGS. 12A and 12B are explanatory diagrams showing activation waveforms in this embodiment;

FIG. 13 is a schematic diagram showing an image-forming apparatus in this embodiment;

FIGS. 14A to 14B are schematic diagrams showing the structure of fluorescent layers used for an image-forming apparatus in this embodiment; and

FIG. 15 is a schematic diagram showing an example of a drive circuit in the image-forming apparatus in this embodiment.

### DESCRIPTION OF THE PREFERRED EMBODIMENTS

Hereafter, though preferable embodiments of the present invention will be explained, the present invention is not limited to these embodiments.

In the present invention, though a substrate for electron source formation on which an electron-emitting device is arranged includes all of the substrates containing Na (soda lime glass, high strain point glass, etc.) and non-alkali glass, the substrate for electron source formation is preferably a glass substrate containing 50 to 85 wt % of SiO₂, and 0 to 17 wt % of Na as a main component.

In addition, though the present inventor et al. understood that the increasing speed of If and Ie at the time of activation first depends on an atmosphere gas at an activation step (type and concentration of the atmosphere gas, a contamination gas, etc.), a current problem is unevenness remaining yet even if they are made to be the same.

The present inventor et al. thought that there was another cause besides the atmosphere gas, and accumulated data of correlation between data such as surface roughness, surface energy, hardness, density, and compactness, and the electron emission characteristic by changing a lot of types of substrates is to zealously examine the data. As a result, it was found that this increasing speed of Ie and If greatly depended on an etching rate of a layer, containing SiO₂, on a surface of the substrate, where the electron-emitting device is formed, in a hydrogen fluoride ammonium solution (NH₄—HF₂). Though there have been still a lot of uncertain portions in the relation between this increasing speed of Ie and If and the etching rate, we confirmed that the SiO₂ layer just under an electron-emitting region was dug up (shaved) when activated, and that there was correlation between this dug condition and the device characteristic. Therefore, we think that there is strong correlation between the success or failure at the activation step and the film quality of the SiO₂ layer, especially the etching characteristic.

Then, as an evidence to support this idea, it was understood that the larger this value was, that is, the large an etching rate was, the later the increasing speed of If at the time of activation tended to be, and that a range of dispersion of data was large and repeatability was bad.

As stated above, the correlation between the value of this etching rate and the electron emission characteristic of an electron source is not physically resolved yet. However, we understand that, even if there are substrates having hardly different surface energy (contact angles with water), hardness, density data, etc., an electron source characteristic such as an arrival value of If may be largely different among the substrates having largely different etching rates. Then, the present inventor et al. think that, since there is a phenomenon in which the SiO₂ layer is dug at the activation step, the film quality of the SiO₂ film apart by only tens nm from a location where electrons are emitted may be effective. As previously stated, we think that the uniformity of film quality of the SiO₂ film in a range of tens nm improves by making the etching rate by hydrofluoric acid small, that is, by increasing the compactness of the film.

In addition, as specific means for slowing down this etching rate, it is cited to bake a layer, where SiO₂ is made a main component, at high temperature as much as possible, for example, at 500° C. or more for a long time, that is, for ten hours or more. Furthermore, it was clarified that it was possible to largely change the etching rate also by process conditions at the time of drying a sol film and the composition of a solvent for dissolving silica sol when the SiO₂ layer was formed from the silica sol obtained by hydrolyzing silicon alkoxide.

Moreover, it was found that, as a result of our zealous research, when the etching rate of a layer on a surface of the substrate, where SiO₂ was made a main component, in a hydrogen fluoride ammonium solution (NH₄—HF₂) became larger than 150 nm/min, the rise speed and final attainment value of If at the time of activation were different in each device, and it was difficult to produce the electronic emission device in good repeatability. In addition, since the value of electron emission quantity (Ie) was small, the electronic emission device was insufficient as an electron-emitting device.

In addition, it was found that it was possible at the etching rate of 100 nm/min or less to obtain the uniformity of values of the electron emission efficiency η (Ie/If: Ie is an emission current here; and If is a device current) among a plurality of devices. Obtaining the uniform efficiency between the plurality of devices is extremely advantageous when an image display unit using an electron source substrate on which a plurality of electron-emitting devices are arranged is produced. That is, owing to a constant ratio of the emission current to the device current among the plurality of devices, it is possible to obtain uniform luminance on a panel (image display unit) with a simple driving method and to perform high-quality image display without performing complex control such as correction of a driving signal.

Then, it was found that it was possible at the etching rate of 30 nm/min or less to make the emission characteristic of the plurality of electron-emitting devices in a screen uniform, and to elongate the life time of the electron-emitting devices, and hence, it was possible to provide an electron source with high uniformity for a long term.

Hereafter, the present invention will be specifically explained on the basis of drawings.

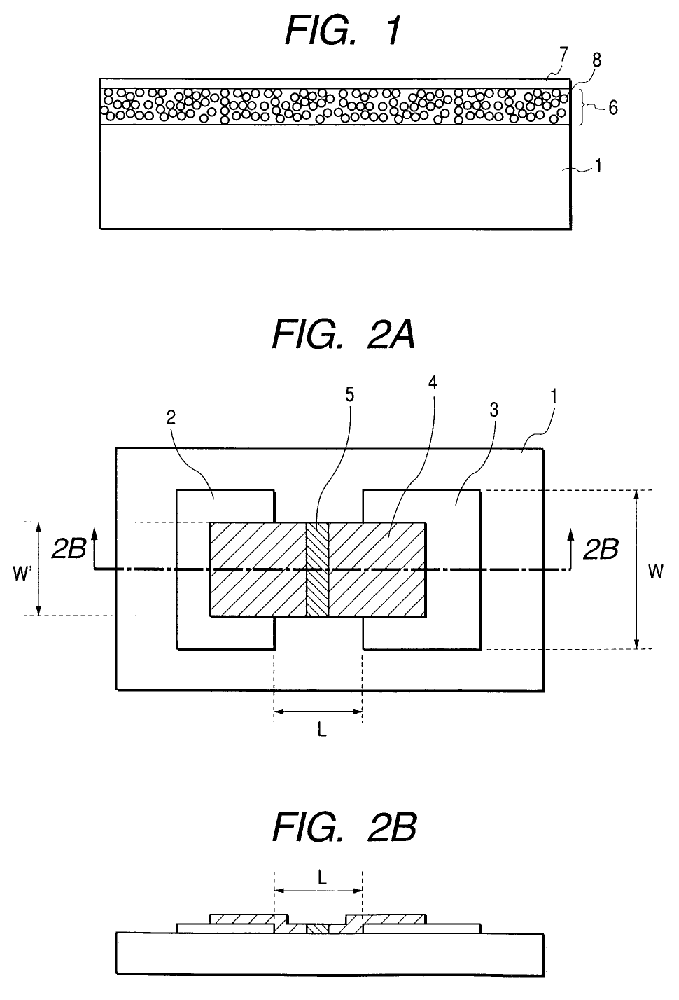

FIG. 1 is a sectional view showing a second embodiment in a substrate for electron source formation according to the present invention.

In FIG. 1, a substrate 1 containing Na is, for example, a substrate made of such as soda lime glass, or high strain point glass where the strain point is raised by substituting K for a part of Na, or a non-alkali glass substrate. Reference numeral 6 denotes a layer containing fine particles of tin oxide, and 7 does a layer where SiO₂ is made a main component. In addition, omission of the layer 6 from this embodiment corresponds to the first embodiment of the present invention.

The layer 7 improves flatness by eliminating irregularity on the layer 6 to facilitate the formation of an electron-emitting device. In addition, since the electronic conductivity oxide is not bonded to the substrate only with the layer 6, the layer 7 plays also a role in performing the bonding, and preventing the electronic conductivity oxide particles (fine tin oxide particles) from dropping out. The more preferable thickness of the layer 7 is 60 nm or more in view of an effect of flatness improvement and an effect of prevention of Na diffusion. In addition, 1 μm or less is furthermore preferable in view of preventing the generation of a crack and film peeling due to the stress of the film.

Next, a typical production method of a substrate for electron source formation will be explained.

As a substrate, the substrate 1 made of material such as soda lime glass, high strain point glass, or non-alkali glass is used, which is sufficiently washed and dried by using a detergent, deionized water, an organic solvent, and the like. The first layer 6 is formed on this substrate 1. An apparatus that was called a slit coater was used for film formation.

A raw material solution for the first layer 6 that contains SnO₂ fine particles was an applying liquid that is constituted by about 5 wt % of fine tin oxide particles 8 (mean particle size expressed by a median value is 20 nm), and an additive of silica sol obtained by hydrolyzing tetramethoxy silane so that SiO₂ might become about 15 wt %. After the layer was dried for about 30 minutes at 80° C. after the application, a next layer was formed.

As a raw material solution for the layer 7 which became a second layer and in which SiO₂ was made a main component, a solution containing 5 wt % of silica sol obtained similarly to the above-mentioned was used. The slit coater was used for this application. Baking at predetermined temperature and time after the application made the first layer 6 covered with the second layer 7.

As mentioned above, the substrate for electron source formation where the first layer 6 and second layer 7 were stacked on the substrate 1 in this order was produced.

In addition, in regard to a forming method of the layer 7, it is also good to form a film by dipping by using a similar applying liquid besides the spin coating method. Furthermore, it is also possible to use a sputtering method or a chemical vapor deposition method.

Moreover, if it is not necessary like non-alkali glass to block the diffusion of sodium to the substrate surface, it is also possible to omit the layer 6.

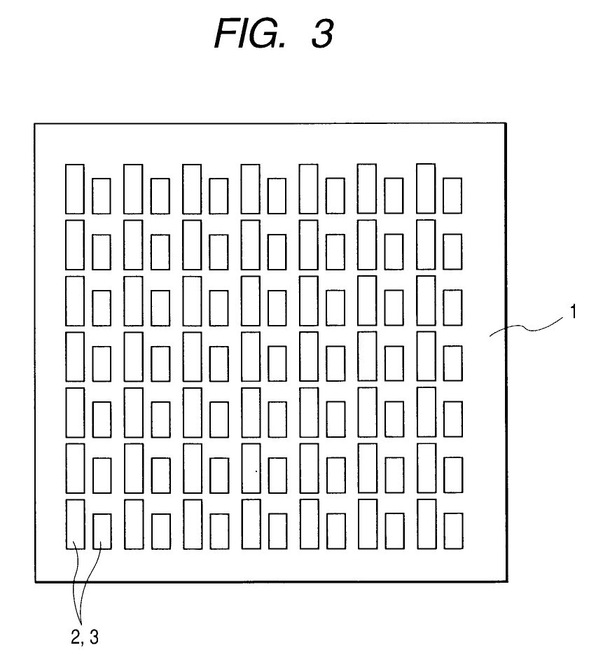

In addition, FIGS. 2A and 2B are a plan and a sectional view that schematically show the basic structure of a surface conduction electron-emitting device. FIG. 2A shows a substrate 1, device electrodes 2 and 3, an electroconductive thin film 4, an electron-emitting region 5, a gap L between the device electrodes, the width W of each of the device electrodes, and the width W′ of the electroconductive thin film.

Next, a simple production method of a display unit in the present invention will be shown.

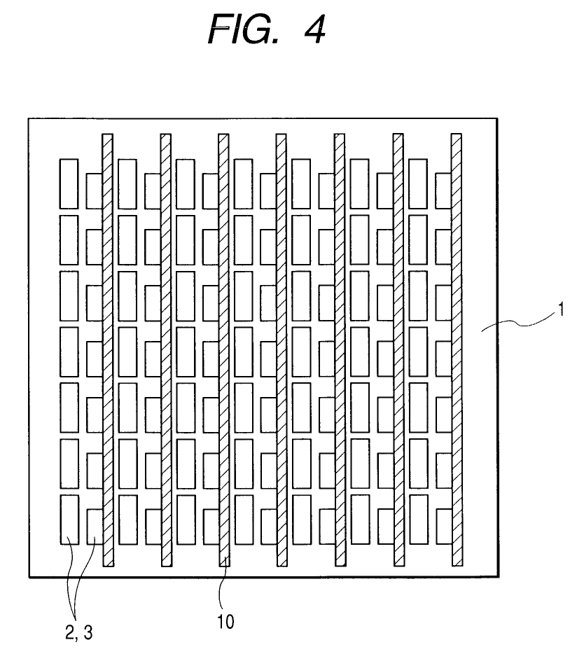

FIGS. 3 to 7 are plans showing each substrate having electron-emitting devices in a matrix.

FIGS. 3 to 7 also show an electron source substrate 1, device electrodes 2 and 3, a Y-directional wiring 10, a insulative film 11, an X-directional wiring 12, and an electroconductive thin film of a surface conduction electron-emitting device 4, which forms the electron-emitting region.

Hereafter, a production method of this device will be explained by using FIGS. 3 to 7.

(Glass Substrate)

In FIG. 3, 2.8-mm thick PD200 glass (made by the Asahi Glass Co., Ltd.) having a strain point higher than that of usual soda lime glass was used.

(Formation of Sodium Block Layer)

As described beforehand in detail, a sodium block layer was formed on the glass substrate 1 by the slit coating method.

(Formation of Device Electrodes)

Moreover, a 5-nm thick titanium film Ti was formed on the glass substrate 1 as an under coating layer by sputtering, a 40-nm thick platinum film Pt was formed thereon, and thereafter, the device electrodes 2 and 3 were formed by applying a photoresist and performing patterning by a photolithography method containing steps of exposure, development, and etching.

In this embodiment, it was made that the gap L between the device electrodes was 10 pm and the width W of each device electrode was 100 μm.

(Formation of Lower Wiring)

Since it is desired that the wiring material of X wiring and Y wiring is low-resistance so that almost equal voltages may be supplied to a lot of surface conduction type devices, the material, film thickness, and width of wiring are properly set.

As shown in FIG. 4, the Y-direction wiring 10 (lower wiring) as common wiring was formed in a line pattern so as to contact with one side of the device electrodes 2 and 3 and to connect them. Silver (Ag) photo paste ink was used as material, was dried after screen printing, was exposed into a predetermined pattern, and was developed. After this, the wiring was formed by baking at the temperature of about 480° C. The size of the wiring after baking was 10 μm of thickness, and 50 μm of line width. In addition, end conditions were made larger in line width so as to use them as wiring-leader electrodes.

(Formation of Insulating Film)

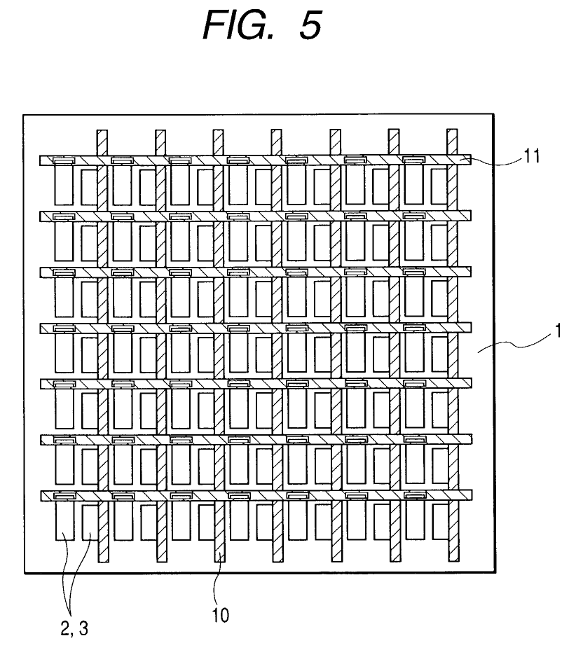

An interlayer insulation layer 11 was arranged to insulate upper and lower wiring as shown in FIG. 5. The interlayer insulation layer 11 was formed under the following X wiring 12 (upper wiring) with providing contact holes in connecting portions so as to cover intersections with the Y wiring (lower wiring) formed beforehand and to make it possible to electrically connect the upper wiring (X wiring) 12 to other sides of the device electrodes.

After photosensitive glass paste whose main component was PbO was screen-printed, exposure and development were performed. This is repeated four times, and the glass paste was baked at the temperature of about 480° C. finally. The thickness of this interlayer insulation layer was about 30 μm as a whole, and width was 150 μm.

(Formation of Upper Wiring)

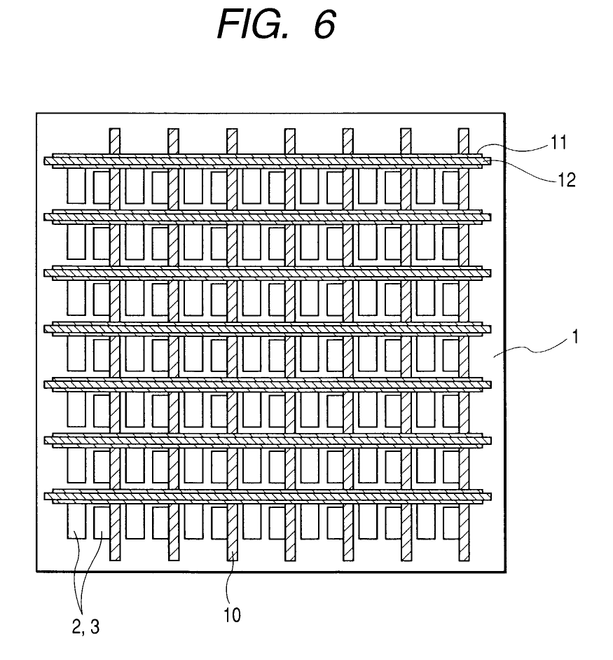

As shown in FIG. 6, the Ag paste ink was screen-printed on the insulating film 11 having formed beforehand and was dried. Double coating was performed by performing similar process on this again. Then, X-directional wiring (upper wiring) 12 was baked at the temperature of about 480° C. The X-directional wiring 12 intersected with the Y-directional wiring (lower wiring) 10 with sandwiching the above-mentioned insulating film 11, and was connected to the other sides of the device electrodes in the contact hole portions of the insulating film 11.

This wiring connected the other device electrodes, which would serve as scanning electrodes after being built in a panel.

The thickness of this X-directional wiring was about 15 μm. The leader wiring with an external drive circuit was formed by a method similar to this.

Leader terminals, which were not shown, to the external drive circuit also were formed by a method similar to this.

Thus, the substrate that had the X-Y matrix wiring was formed.

(Formation of Device Film)

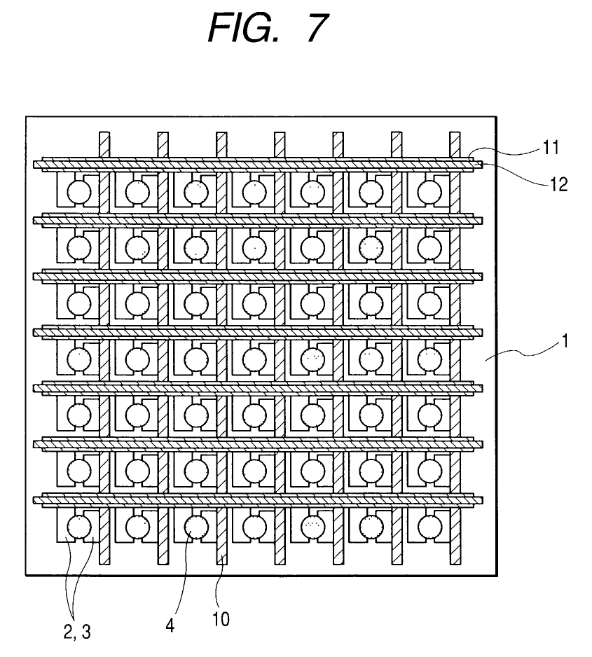

As shown in FIG. 7, after cleaning the above-mentioned substrate enough, a surface of the substrate was processed with a solution including a water repellent to make the surface hydrophobic. This aimed at a solution for device film formation applied after this to be arranged on the device electrodes 2 and 3 in proper extension.

The water repellent used was an ethyl alcohol solution of dimethoxydiethoxysilane (DDS), which was scattered on the substrate by the spraying method and was dried at 120° C. by a heater.

Thereafter, the electroconductive thin film 4 was formed between the device electrodes 2 and 3 by an inkjet applying method.

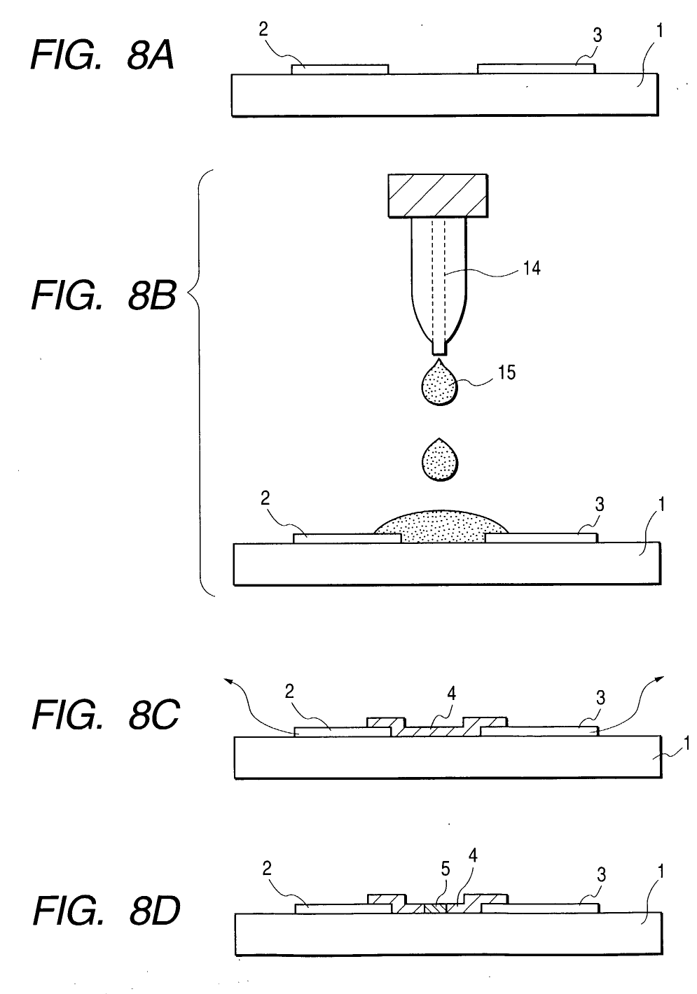

FIGS. 8A to 8D show schematic diagrams of this process. FIGS. 8A to 8D show a substrate 1, device electrodes 2 and 3, an electroconductive thin film 4, an electron-emitting region 5, droplet supplying means 14, and a droplet 15.

In this embodiment, in order to obtain a palladium film as the electroconductive thin film 4, first of all, an organopalladium solution was obtained by dissolving 0.15 wt % of palladium-proline complexation in a solution composed of 85% of water and 15% of isopropyl alcohol (IPA). Besides this, some additives were applied.

A droplet of this solution was supplied between the electrodes by using an inkjet injection system using a piezoelectric element as the droplet supply means 14 and adjusting the droplet supply means 14 so that dot diameter may become 60 μm. Thereafter, palladium oxide (PdO) was made by performing this substrate in air-heating and baking process at 350° C. for ten minutes. The diameter of the dot obtained was about 60 μm and the maximum film thickness was 10 nm.

The palladium oxide (PdO) film was formed in the device portion by the above-mentioned process.

(Reduction Forming)

As shown in FIGS. 8C and 8D, in this process that is called forming, the electron-emitting region 5 is formed by performing the energizing process of the above-mentioned electroconductive thin film 4 to make a crack internally arise.

A specific method is as follows. A vacuum space is made internally between the substrate by covering the entire substrate with a hood-like lid except the leader electrode portions in the periphery of the above-mentioned substrate. Then a voltage from an external power supply is applied between the X and Y wirings from the electrode terminal portions to perform energization between the device electrodes. Furthermore, the electron-emitting region 5 having electrically high resistance is formed by locally destroying, transforming or changing the quality of the electroconductive thin film 4.

At this time, since reduction is promoted with hydrogen by energizing and heating the electron-emitting region 5 under vacuum atmosphere including some degree of hydrogen gas, palladium oxide (PdO) changes to a palladium (Pd) film. Though a crack is partially caused by the reduction shrinkage of the film at the time of this change, a developmental position and a shape of the crack are greatly influenced by the uniformity of the original film.

In order to suppress the characteristic dispersion of plenty of devices, it is most desirable that the above-mentioned crack arises in a central portion and becomes straight as much as possible.

In addition, though electron emission occurs under a predetermined voltage from the vicinity of the crack formed by this forming, a developmental efficiency is still very low under current conditions.

Moreover, the resistance Rs of the electroconductive thin film 4 that was obtained was among from 10² to 10⁷ Ω.

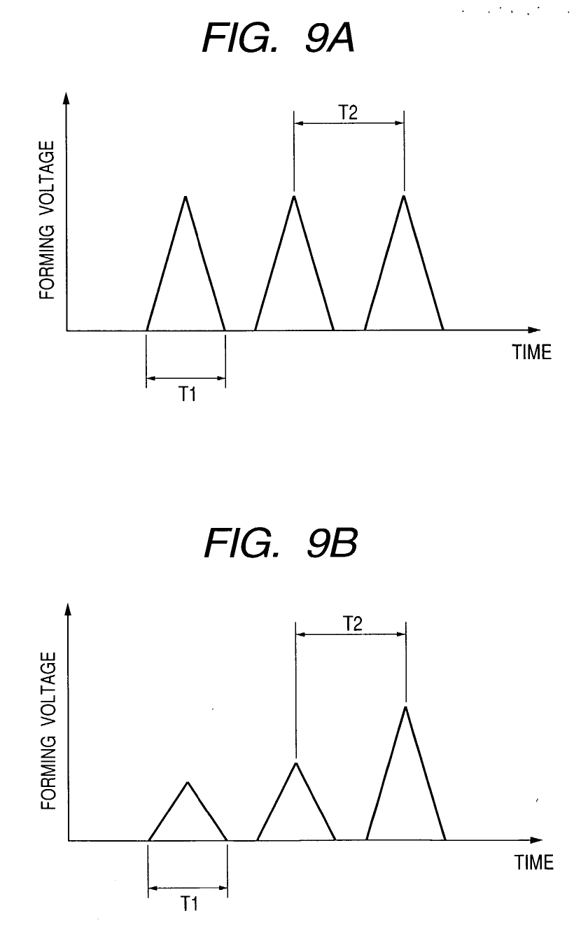

Voltage waveforms used in forming process will be simply explained. FIGS. 9A and 9B are explanatory diagrams showing forming waveforms in this embodiment.

Though the voltages applied had pulse waveforms, there are a case that a pulse amplitude whose pulse peak value is a constant voltage is applied (FIG. 9A), and a case that a pulse amplitude whose pulse peak value is increased (FIG. 9B).

In FIG. 9A, T1 and T2 are pulse width and a pulse interval of a voltage waveform. T1 is made to be 1 μsec to 10 msec, T2 is made to be 10 μsec to 100 msec, and a peak value of a triangular wave (peak voltage at the time of forming) is properly selected.

In FIG. 9B, values of T1 and T2 are made equal, and the peak value of the triangular wave (peak voltage at the time of forming) is increased, for example, approximately by 0.1 V.

In addition, the termination of forming process was made as follows. A voltage that does not locally destroy or transform the electroconductive thin film 4, for example, a pulse voltage of about 0.1 V is inserted between forming pulses to measure a device current and obtain resistance. A point when the resistance indicated, for example, 1000 times or more of value as large as the resistance before the forming process was made to be a point of the termination of forming process.

(Activation: Carbon Deposition)

The electron emission efficiency is very low under such a condition as previously mentioned. Therefore, it is desirable to perform the processing that is called activation for the above-mentioned device so as to improve an electron emission efficiency.

This processing is performed under the suitable degree of vacuum where an organic compound exists similarly to the above-described forming. That is, a vacuum space is made internally between the substrate by covering the entire substrate with a hood-like lid. Then a pulse voltage from the external is repeatedly applied to the device electrodes through the X and Y wirings. The pulse voltage is repeatedly applied to the device electrodes. Then, a gas including carbon atoms is introduced, and carbon derived from the gas or a carbon compound is deposited in the vicinity of the above-described crack as a carbon film.

At this step, trinitryl was used as a carbon source, and was introduced in the vacuum space through a slow leak valve to maintain 1.3×10⁻⁴ Pa. The preferable pressure of the introduced trinitryl gas is about 1×10⁻⁵ Pa to 1×10⁻² Pa though this is influenced somewhat by a shape of a vacuum device, a member used for the vacuum device, or the like.

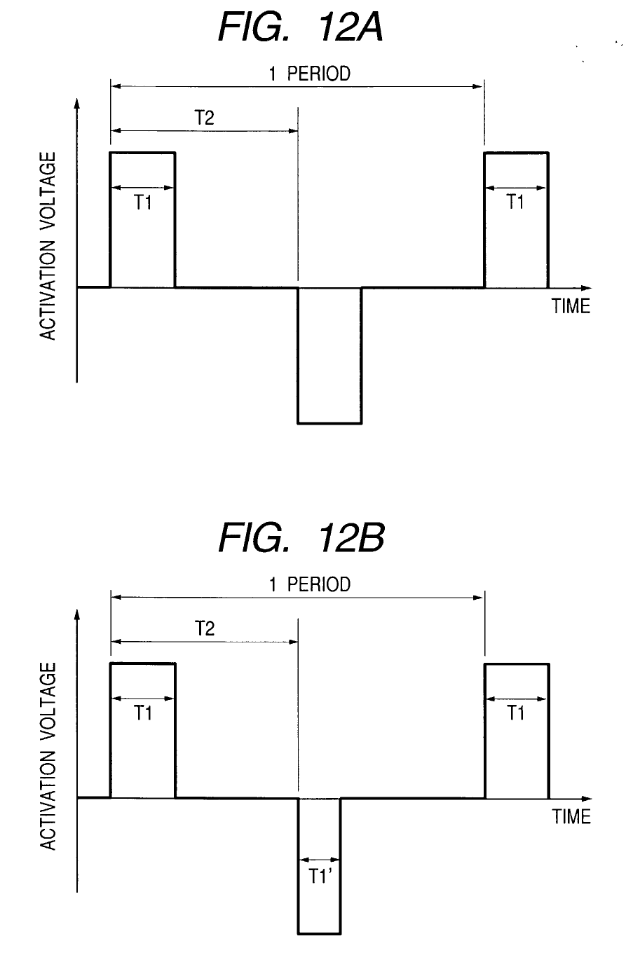

FIGS. 12A and 12B show preferable examples of application of voltages used at the activation step. The value of a maximum voltage applied is properly selected within a range of 10 to 20 V. FIG. 12A shows the positive or negative pulse width T1 of a voltage waveform, and the pulse interval T2, and absolute values of the positive and negative voltages are equally set. FIG. 12B shows respective positive or negative pulse width T1 and T1′ of a voltage waveform, and a pulse interval T2 (T1>T1′), and absolute values of the positive and negative voltages are equally set.

At this time, since it was made a voltage given to the device electrode 3 positive, the positive direction of the device current If was the direction from the device electrode 3 to the device electrode 2. When the emission current Ie almost reached a saturation point after about 60 minutes, energization was stopped, the slow leak valve was closed, and the activation processing was ended.

The substrate that had the electron source device could be made in the above-mentioned processing.

(Sealing: Panel Production)

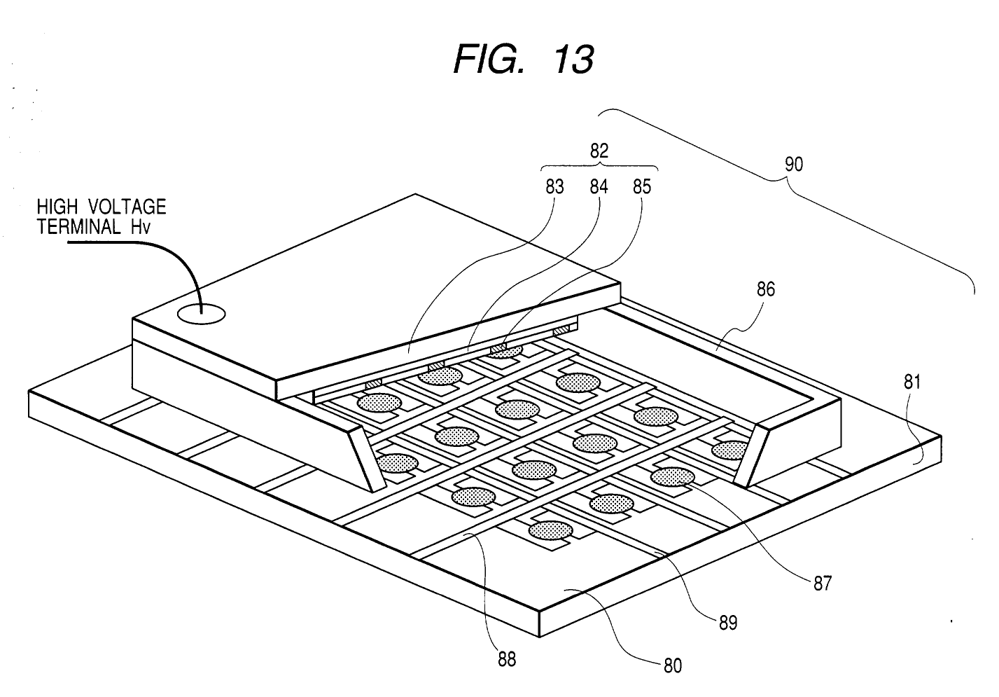

Examples of an electron source that uses the above-mentioned electron source substrate in simple matrix arrangement and an image-forming apparatus used for display etc. will be explained by using FIG. 13.

FIG. 13 shows an electron source substrate 80 where a lot of electron-emitting devices are arranged, and a glass substrate 81, which is called a rear plate. FIG. 13 also shows a face plate 82 where a fluorescent layer 84, a metal backing 85, etc. are formed inside a glass substrate 83. An envelope 90 is formed by bonding a support frame 86, the rear plate 81, and, the face plate 82 with frit glass, and performing sealing by baking them at 400 to 500° C. for ten minutes or more.

Performing a series of steps in a vacuum chamber made it possible to make the inside of the envelope 90 vacuum from the beginning at the same time, and simplified the steps.

In FIG. 13, reference numeral 87 corresponds to the electron-emitting device of the present invention. Reference numerals 88 and 89 denote X- and a Y-directional wirings connected to a couple of device electrodes of each surface conduction electron-emitting device.

On the other hand, it is possible to constitute the envelope 90, having enough strength against atmospheric pressure even in a large area panel by installing a supporting member, which is not shown and is called a spacer, between the face plate 82 and rear plates 81.

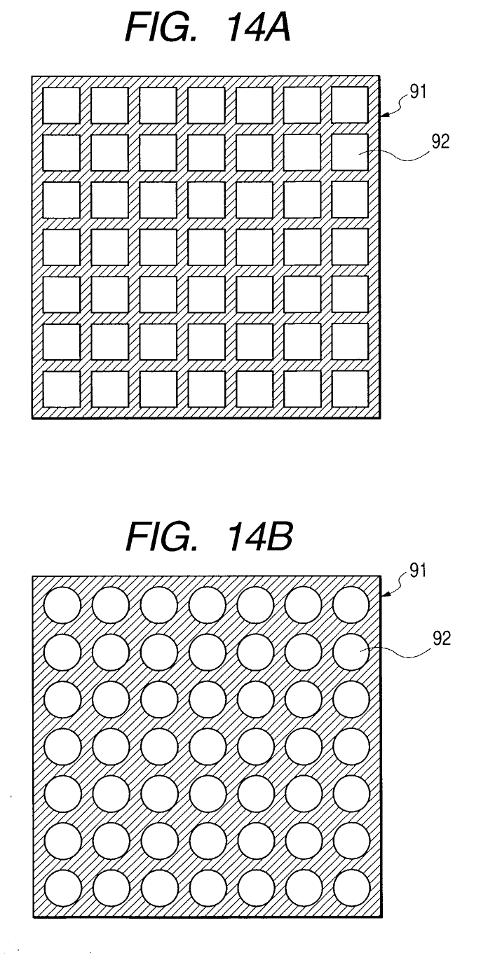

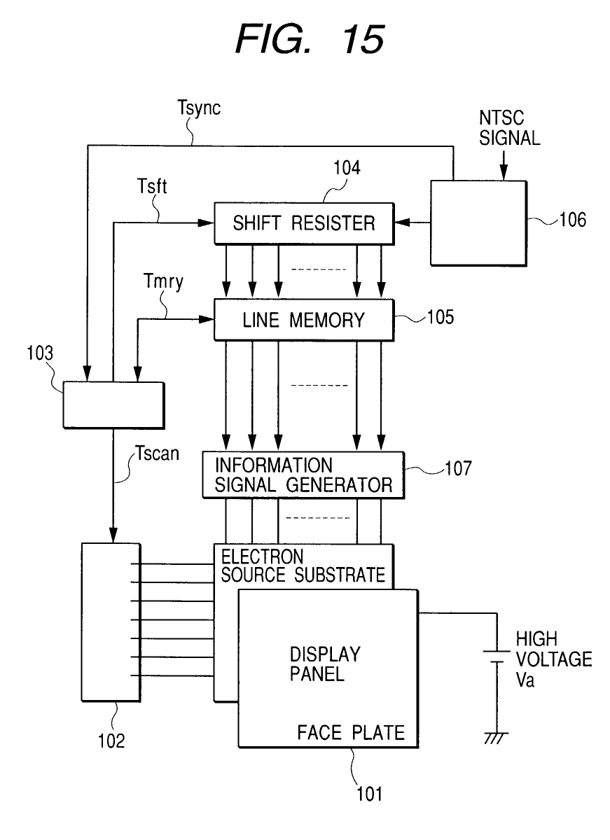

FIG. 14 is an explanatory diagram of a fluorescent layer provided on the face plate.

A degree of vacuum at sealing is required to be about 1.3×10⁻⁵ Pa, and further, gettering may be performed so as to maintain the degree of vacuum after the envelope 90 is sealed. This is the processing of forming an evaporated film by heating getter, arranged at a predetermined position (not shown) in the envelope 90, by a heating method such as resistance heating or high-frequency heating immediately before the sealing of the envelope 90 or after the sealing. Usually, a main component of the getter is Ba and the like, which maintain the degree of vacuum of, for example, 1.3×10⁻³ Pa or 1.3×10⁻⁵ Pa by the adsorption of the evaporated film.

(Image-forming Apparatus)

According to a fundamental characteristic of the above-mentioned surface conduction electron-emitting device according to the present invention, emission electrons from the electron-emitting region are controlled by a peak value and the width of a pulsating voltage applied between the faced device electrodes at a threshold voltage or more. Furthermore, current quantity is also controlled at their mean values, and hence, half tone display is possible.

Moreover, properly applying the above-mentioned pulsating voltage to an individual device through each information signal line after determining a selected line by a scanning line signal in each line when a lot of electron-emitting devices are arranged makes it possible to properly apply a voltage to an arbitrary device, and hence, makes it possible to turn on each device.

In addition, as a system to modulate an electron-emitting device according to an input signal having half tone, a voltage modulation system and a pulse-width modulation system can be mentioned.

### EXAMPLES

Hereafter, though the present invention will be explained by specific examples in detail, the present invention is never limited to these examples, the present invention also includes those, where each component is substituted or modified in design, within a scope where objects of the present invention are achieved.

(Evaluation Method of Etching Rate)

A characteristic of the present invention is the film quality of a formed SiO₂ film, which was evaluated by a corrosion rate of the SiO₂ film with hydrofluoric acid.

An etchant was obtained by diluting 20.0% (6:1) of high-purity buffered hydrofluoric acid (NH₄—HF₂), made by Stella Chemifa Corporation, into 0.4% solution with deionized water. A reason why this concentration was selected was that the accuracy of an experiment was lost since the corrosion rate was too fast for those having each excessively large etching rate when evaluation was performed in an excessively high concentration. On the other hand, when the concentration was too low, the experiment would need much time.

The etching rate was measured as follows.

First of all, about 500 μm line & space patterning of a photoresist was performed on a surface of the SiO₂ layer to be measured, and thereafter, etching was performed with soaking the substrate in the etchant while slowly stirring the etchant. The temperature of the etchant at this time was made to become 23° C. Thereafter, the photoresist was peeled off with an organic solvent such as methyl ethyl ketone. Then, a step between a location, which was covered by the photoresist, and an etched location was measured with a stylus type profiler (Alpha Step 500), and the measurement was made to be etch depth. The above-mentioned procedure was repeated for every three or more locations with changing the etching time respectively, and etch depth per minute, that is, the etching rate was obtained by using the least squares method.

(Evaluation Method of Activation Characteristic in Present Invention)

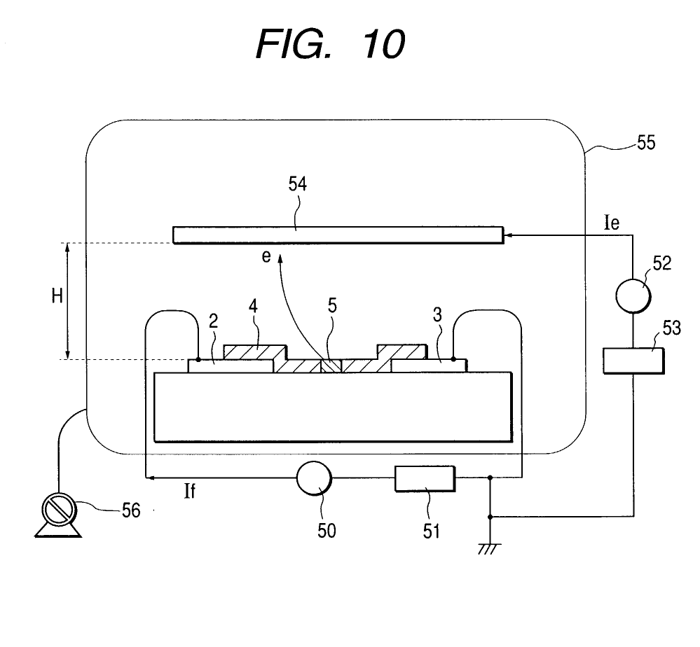

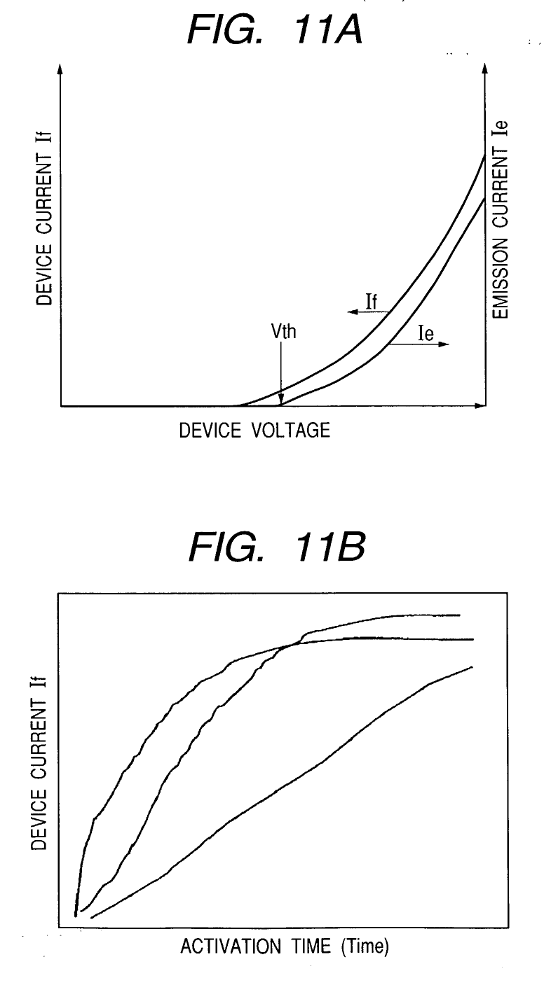

An evaluation method of characteristics in an activation step after the production of the electron-emitting device that was produced on the substrate for electron source formation according to the present invention as explained in detail in the embodiments of the present invention will be explained by using FIGS. 10 and 11.

FIG. 10 is a schematic diagram of measuring and evaluating equipment to measure an electron emission characteristic of a device having the above-mentioned structure.

For the measurement of the device current If that flows between device electrodes of the electron-emitting device, and the emission current Ie to an anode, a power supply 51 and an ammeter 50 were connected to the device electrodes 2 and 3, and an anode electrode 54 to which a power supply 53 and an ammeter 52 were connected was arranged above the electron-emitting device.

FIG. 10 shows the device electrodes 2 and 3, the thin film 4 including the electron-emitting region, and the electron-emitting region 5. Moreover, FIG. 10 also shows the power supply 51 to apply a device voltage Vf to the device, the ammeter 50 to measure the device current If that flows in the electroconductive thin film 4 including an electronic sweeping portion between the device electrodes 2 and 3, the anode electrode 54 to catch the emission current Ie discharged from the electron-emitting region of the device, the high voltage power supply 53 to apply a voltage to the anode electrode 54, and the ammeter 52 to measure the emission current Ie discharged from the electron-emitting region 5 of the device.

Moreover, this electron-emitting device and anode electrode 54 were installed in a vacuum device, in which necessary equipment for the vacuum device such as an exhaust pump and a vacuum gauge that were not shown was provided. Hence, it was made to be able to measure and evaluate the present device under a desired degree of vacuum.

Activation conditions were that a maximum voltage of a pulse applied to the device was 16 V, and application time was 60 minutes. In addition, trinitryl was used as a carbon source, and was introduced in the vacuum space through a slow leak valve to maintain 1.3×10⁻⁴ Pa.

FIG. 11B shows an example of aging of the device current If at the time of typically activation that was measured by the measuring and evaluating equipment shown in FIG. 10. There were cases demonstrating various behaviors: one behavior that the current If grows immediately after the beginning of activation; another behavior that the current If increases almost evenly; and still another behavior that a maximum value which the current If finally reaches different. Though some typical patterns were shown and there is no ideal pattern, what is good is a pattern having a good repeatability of an If arrival point.

### EXAMPLES

### Examples 1 to 5

In these examples, the electron-emitting devices shown in FIGS. 2A and 2B were produced by forming device electrodes and an electroconductive thin film after producing substrates for electron source formation, shown in Table 1, according to the production process shown in FIGS. 3 to 7. In addition, a solvent system is a type of a main solvent of a solution where silica sol that becomes an applying liquid to a SiO₂ film is dissolved, and contains some quantity of water, methanol, etc.

In these examples and the following comparative examples, six devices were produced on each identical substrate, and the repeatability of their characteristics was compared and investigated.

TABLE 1

| | | SnO₂ | | | | | | |
|---|---|---|---|---|---|---|---|---|
| | | Fine | | | Baking | Baking | Etching | |
| | Substrate | Particle | SiO₂ | Solvent | Temperature | Time | Rate | Characteristic |
| | Glass | Layer | Layer | System | (deg.) | (hrs) | (nm/min) | Evaluation Result |
| Ex. 1 | PD200 | 300 | 60 | Alcohol | 500 | 2 | 12 | Good Ie uniformity |
| | | nm | nm | | | | | among a plurality of |
| | | | | | | | | devices |
| Ex. 2 | PD200 | 250 | 100 | Glycol | 500 | 2 | 96 | Good characteristic, |
| | | nm | nm | | | | | but some dispersion of |
| | | | | | | | | Ie uniformity when long |
| | | | | | | | | driving |
| Ex. 3 | PD200 | 250 | 100 | Glycol | 500 | 10 | 24.8 | Good Ie uniformity |
| | | nm | nm | | | | | among a plurality of |
| | | | | | | | | devices |
| Ex. 4 | PD200 | No | 600 | Sputter- | 480 | 2 | 8.6 | Good Ie uniformity |
| | | | nm | ing | | | | among a plurality of |
| | | | | | | | | devices |
| Ex. 5 | Non- | No | 100 | Glycol | 500 | 10 | 24.8 | Good Ie uniformity |
| | alkali | | nm | | | | | among a plurality of |
| | | | | | | | | devices |
| Ex. 6 | OA-10 | No | 100 | Glycol | 480 | 2 | 150 | Good characteristic, |
| | | | nm | | | | | but some dispersion of |
| | | | | | | | | Ie uniformity |

In Table 1, in a first example, PD200 was adopted as substrate glass, on which 300 nm of a SnO₂ fine particle layer and 60 nm of a SiO₂ layer were formed. Alcohol was selected as the solvent system, and baking was performed at 500° C. for two hours. Then, the etching rate was 12 nm/min.

In a second example, PD200 was adopted as substrate glass, on which 250 nm of a SnO₂ fine particle layer and 100 nm of a SiO₂ layer were formed. Glycol was selected as the solvent system, and baking was performed at 500° C. for two hours. Then, the etching rate was 96 nm/min.

In a third example, PD200 was adopted as substrate glass, on which 250 nm of a SnO₂ fine particle layer and 100 nm of a SiO₂ layer were formed. Glycol was selected as the solvent system, and baking was performed at 500° C. for 10 hours. Then, the etching rate was 24.8 nm/min.

In a fourth example, PD200 was adopted as substrate glass, on which 600 nm of a SiO₂ layer was formed. Sputtering was selected without the solvent system, and baking was performed at 480° C. for two hours. Then, the etching rate was 8.6 nm/min.

In a fifth example, non-alkali glass was adopted as substrate glass, on which 100 nm of a SiO₂ layer was formed. Glycol was selected as the solvent system, and baking was performed at 500° C. for 10 hours. Then, the etching rate was 24.8 nm/min.

In a sixth example, non-alkali glass was adopted as substrate glass, on which 100 nm of a SiO₂ layer was formed. Hexylene glycol was selected as the solvent system, and baking was performed at 480° C. for two hours. Then, the etching rate was 150 nm/min.

As shown in Table 1, in the substrates having the structure shown in the first to fifth examples, all the etching rates were 100 nm/min or less. Moreover, the etching rate was 150 nm/min in the sixth example. In addition, etching conditions were as shown in the above-mentioned, and hence, etching was performed by using the etchant of 0.4% of hydrogen fluoride ammonium solution (NH₄—HF₂) at the temperature of 23° C.

The evaluation result showed excellent device characteristics that all the six produced devices had good repeatability in each substrate, that the rise of the device current If at the time of activation was fast, and that values of If arrival points were almost equal. Moreover, devices having enough electron emission characteristics were obtained.

Next, matrix wiring was given to the substrate produced in the third example, an electron-emitting device was formed in each intersection, and the substrate was made a rear plate. Moreover, a panel was produced by vacuum-sealing the rear plate with the face plate and frit that were separately produced, and was evaluated as an image-forming apparatus. Then, when being connected to a drive circuit and driven, this panel could display an excellent image for a long time.

### Comparative Examples

Next, as comparative examples, examples having each etching rate exceeding 150 nm/min, or, examples not having the structure of the present invention are shown in Table 2.

TABLE 2

| | | SnO₂ | | | Baking | | | |
|---|---|---|---|---|---|---|---|---|
| | | Fine | | | Temper- | Baking | Etching | |
| | Substrate | Particle | SiO₂ | Solvent | ature | Time | Rate | Characteristic |
| | Glass | Layer | Layer | System | (deg.) | (hrs) | (nm/min) | Evaluation Result |
| Com. | Soda | No | No | | | | | Not activated |
| Ex. 1 | lime | | | | | | | |
| | glass | | | | | | | |
| Com. | PD200 | No | No | | | | | Not activated |
| Ex. 2 | | | | | | | | |
| Com. | PD200 | 300 | 60 | Alcohol | 275 | 2 | 162 | Improper for image display |
| Ex. 3 | | nm | nm | | | | | because of large dispersion of |
| | | | | | | | | If and Ie among a plurality of |
| | | | | | | | | devices |
| Com. | PD200 | 250 | 100 | Glycol | 275 | 2 | 558 | Improper as a device because |
| Ex. 4 | | nm | nm | | | | | of unstable activation |
| Com. | PD200 | 250 | 100 | Glycol | 400 | 2 | 480 | Improper as a device because |
| Ex. 5 | | nm | nm | | | | | of unstable activation |

In Table 2, a first comparative example is an example of adopting soda lime glass as substrate glass, and using the soda lime glass as it is without providing a coating film on its surface.

A second comparative example is an example of adopting PD200 as substrate glass, and using the PD200 as it is without providing a coating film on its surface.

In a third comparative example, PD200 was adopted as substrate glass, on which 300 nm of a SnO₂ fine particle layer and 60 nm of a SiO₂ layer were formed. Alcohol was selected as the solvent system, and baking was performed at 275° C. for two hours. Then, the etching rate was 162 nm/min.

In a fourth comparative example, PD200 was adopted as substrate glass, on which 250 nm of a SnO₂ fine particle layer and 100 nm of a SiO₂ layer were formed. Glycol was selected as the solvent system, and baking was performed at 275° C. for two hours. Then, the etching rate was 558 nm/min.

In a fifth comparative example, PD200 was adopted as substrate glass, on which 250 nm of a SnO₂ fine particle layer and 100 nm bf a SiO₂ layer were formed. Glycol was selected as the solvent system, and baking was performed at 400° C. for two hours. Then, the etching rate was 480 nm/min.

In the first and second comparative examples, the increase of the device current was hardly observed at the activation step, and hence, the first and second comparative examples were not excellent electron-emitting devices.

Moreover, in the third to fifth comparative examples, the increase of the device current If was observed at the time of activation. However, they were not electron-emitting devices that could be adopted as image-forming apparatuses with uniformity since they did not have repeatability in the characteristics of the electron-emitting devices: rise was slow; and about 40% of dispersion of the currents If and Ie at the maximum were measured in six devices compared in the same structure.

### Advantages of the Invention

As explained above, the present invention can provide a substrate for electron source formation that can reduce the time-dependent change of an electron emission characteristic of an electron-emitting device in low cost, can sharply improve the increasing speed of a device current If and the uniformity of final arrival values of If, and can sharply reduce the dispersion of the electron emission characteristic, and an electron source and an image-forming apparatus that each use the substrate.

What is claimed is:

1. A substrate for electron source formation on which a plurality of electron-emitting devices are arranged, comprising a layer where SiO₂ is made a main component on the substrate, wherein an etching rate of the SiO₂ layer at room temperature in 0.4 wt % of hydrogen fluoride ammonium solution (NH₄—HF₂) is 150 nm/min or less.

2. A substrate for electron source formation on which a plurality of electron-emitting devices are arranged, comprising a layer where SiO₂ is made a main component on the substrate, wherein an etching rate of the SiO₂ layer at room temperature in 0.4 wt % of hydrogen fluoride ammonium solution (NH₄—HF₂) is 100 nm/min or less.

3. A substrate for electron source formation on which a plurality of electron-emitting devices are arranged, comprising a layer where SiO₂ is made a main component on the substrate, wherein an etching rate of the SiO₂ layer at room temperature in 0.4 wt % of hydrogen fluoride ammonium solution (NH₄—HF₂) is 30 nm/min or less.

4. A substrate for electron source formation on which a plurality of electron-emitting devices are arranged, comprising a layer where SiO₂ is made a main component on the substrate, wherein the layer whose main component is SiO₂ is formed by baking silica sol obtained by hydrolyzing silicon alkoxide, and wherein an etching rate of the SiO₂ layer at room temperature in 0.4 wt % of hydrogen fluoride ammonium solution (NH₄—HF₂) is 150 nm/min or less.

5. A substrate for electron source formation on which a plurality of electron-emitting devices are arranged, comprising a layer where SiO₂ is made a main component on the substrate, wherein the layer whose main component is SiO₂ is formed by baking silica sol obtained by hydrolyzing silicon alkoxide, and wherein an etching rate of the SiO₂ layer at room temperature in 0.4 wt % of hydrogen fluoride ammonium solution (NH₄—HF₂) is 100 nm/min or less.

6. A substrate for electron source formation on which a plurality of electron-emitting devices are arranged, comprising a layer where SiO₂ is made a main component on the substrate, wherein the layer whose main component is SiO₂ is formed by baking silica sol obtained by hydrolyzing silicon alkoxide, and wherein an etching rate of the SiO₂ layer at room temperature in 0.4 wt % of hydrogen fluoride ammonium solution (NH₄—HF₂) is 30 nm/min or less.

7. The substrate for electron source formation according to claim 1, further comprising a layer whose main component is fine particles of tin oxide (SnO₂) as a first layer under the layer whose main component is SiO₂.

8. The substrate for electron source formation according to claim 7, wherein mean particle size of fine particles of tin oxide (SnO₂) that is a main component in the first layer is between 15 to 30 nm, the mean particle size that is expressed in a median value.

9. The substrate for electron source formation according to claim 7, wherein a main component of the first layer is fine particles of tin oxide (SnO₂) and 0.5 to 10 wt % of phosphorus (P) is contained in the layer.

10. An electron source comprising the substrates for electron source formation according to claim 1, a plurality of electron-emitting devices arranged on a layer where SiO₂ is made a main component, and a plurality of row-directional wirings and a plurality of column-directional wirings that connect the plurality of electron-emitting devices in a matrix.

11. An image-forming apparatus comprising the electron source according to claim 10, an image-forming member in which an image is formed by radiating electrons emitted from the electron source.
